(19) United States
(12) Patent Application Publication
(10) Pub. No.: US 2023/0093024 A1
(43) Pub. Date: Mar. 23, 2023

(54) OPERATING AN APPLICATION OF A ROBOT SYSTEM

(71) Applicant: KUKA Deutschland GmbH, Augsburg (DE)

(72) Inventors: Jürgen Bock, Augsburg (DE); Zhicong Xian, Augsburg (DE)

(21) Appl. No.: 17/795,460

(22) PCT Filed: Feb. 4, 2021
(86) PCT No.: PCT/EP2021/052591

§ 371 Date: Jul. 26, 2022

(30) Foreign Application Priority Data
Feb. 5, 2020 (DE) 10 2020 201 398.5

(51) Int. Cl. B25J 9/16

(52) U.S. Cl. CPC B25J 9/1661; B25J 9/1671; B25J 9/1674; G05B 2219/32137; G05B 2219/34202; G05B 2219/36174

(57) ABSTRACT

A method for operating an application of a robot system includes selecting a first robot system situation module from a situation module library that comprises a plurality of predefined application-independent robot system situation modules for the robot system, each of which modules maps at least one input signal onto at least one output signal; linking the first robot system situation module to at least one additional selected robot system situation module from the situation module library, and/or to at least one application-class-specific application class situation module that is predefined for a class of a plurality of applications and maps at least one input signal onto at least one output signal, and/or to at least one application-specific application situation module that maps at least one input signal onto at least one output signal, to form a first application situation module that maps the input signals of its linked situation modules onto at least one output signal; and operating the application on the basis of the first application situation module.

### CROSS-REFERENCE TO RELATED APPLICATIONS

This application is a national phase application under 35 U.S.C. § 371 of International Patent Application No. PCT/EP2021/052591, filed Feb. 4, 2021 (pending), which claims the benefit of priority to German Patent Application No. DE 10 2020 201 398.5, filed Feb. 5, 2020, the disclosures of which are incorporated by reference herein in their entirety.

### TECHNICAL FIELD

The present invention relates to a method and system for operating an application of a robot system, and a situation module library and a computer program product for carrying out the method.

### BACKGROUND

The robot-based automation, in particular of production jobs, generally requires robot systems having a number of resources such as robots, end-effector, sensors, fixings, transport equipment, in particular conveying equipment and the like, and what is known as a system integrator, which combines these resources to form a robot system, in particular a robot cell.

Furthermore, an application developer is required, which carries out the programming of the individual components. The role of the application developer is frequently also undertaken by the system integrator.

Static applications can be implemented in this way, having sometimes very high integration or programming outlay, and are economic, if the savings due to automation compensate for this integration or programming outlay, i.e. typically in the case of production of high numbers of pieces in facilities having a long operating time.

The integration or programming outlay increases significantly if the application is intended to be used not statically but rather flexibly for a plurality of tasks or variants. This is in particular on account of the fact that a significantly larger variety of conditions, errors and other eventualities have to be taken into account during the execution.

Completely covering all eventualities is very complex, and therefore often uneconomic and thus a stumbling block precisely in the case of small and medium-sized enterprises (SMEs), which, however, could benefit greatly from flexible automation solutions.

An alternative to completely covering all eventualities is to be able to react easily and flexibly to newly arising situations during the execution, and to possible errors. For this purpose, however, an expert, in this case the application developer or system integrator, must be consulted ad hoc. Here as well, SMEs, as typical users, are in a difficult situation, as they generally do not have their own in-house application developers or system integrators.

The difficulty is intensified in that the different components within the automation cell are per se closed systems, and as a result also offer the user a heterogeneous landscape. The user is thus confronted with a plurality of different descriptions of different systems, including the process or application description of the application developer or system integrator, which is again different.

An example for the problem depicted is a robot (system) application for automatically setting electrical terminals on a DIN rail within the context of electric cabinet assembly: the components are removed, by a robot having a mounted universal gripper, from a box and clipped onto the DIN rail in a force-regulated manner. Various factors can result in the snapping-in on the DIN rail failing, for example an incorrect component, a faulty snap mechanism, a DIN rail that is not present or is arranged at the wrong angle, components that are not present, or the like. Depending on the error, the cause may be traced back to a single resource, e.g. the robot or the gripper, or also to the process, or external factors. In this case, an inexperienced user is generally not capable of specifically isolating and eliminating the cause of error. Furthermore, the application developer or system integrator, who is capable of this, is typically not on site, or expensive to consult.

Approaches used internally hither to are specific for a given application.

In particular in the case of evaluating the application and resource data by machine learning methods, the learned model is dependent on the application or the specific configuration. For example, if the mounting position used during learning changes, in some cases the model may no longer be valid and can no longer identify causes of error. The same applies for an ontology-based or rule-based approach, if this describes situations which are inherently linked to the present application.

### SUMMARY

The object of the present invention is that of improving the operation of an application of a robot system, and preferably reducing, preferably preventing, one or more of the above-mentioned disadvantages.

This object is achieved by a method, a system, computer program product, or a situation module library for carrying out a method as described herein.

According to one embodiment of the present invention, a method for operating an application of a robot system comprises the following steps:

selecting a robot system situation module, which is referred to in the present case, without limiting the generality, as a first robot system situation module, from a situation module library,

which comprises a plurality of predefined application-independent robot system situation modules for the robot system,

which in each case map one or more input signals onto one or more output signals, in particular are provided, in particular designed, or are used for this purpose;

linking this first robot system situation module to

one or more additional selected robot system situation modules from the situation module library; and/or

one or more application-class-specific application class situation modules,

which are (each) predefined for a class of a plurality of, in particular identical, applications, and

which (each) map one or more input signals onto one or more output signals, in particular are provided, in particular designed, or are used for this purpose; and/or

one or more application-specific application situation modules,

which (each) map one or more input signals onto one or more output signals, in particular are provided, in particular designed for this purpose, or are used for this purpose,

to form an application situation module, which in the present case is referred to, without limiting the generality, as the first application situation module and maps input signals of its linked situation modules, i.e. the first robot system situation module, and the further selected robot system situation module(s), and/or the application class situation module(s) and/or the application situation module(s) linked thereto, onto one or more output signals, in particular is provided, in particular designed for this purpose, or is used for this purpose; and

operating the application on the basis of the first application situation module.

A key concept of one embodiment of the present invention consists in providing or using a situation module library, which comprises a plurality of predefined application-independent robot system situation modules for a or the robot system, which in each case maps at least one input signal onto at least one output signal, and creating therefrom, by means of linking, an application-specific application situation module, or providing or using an application situation module, created in this way, for operating an application of a robot system.

As a result, in one embodiment robot system situation modules can advantageously be created or provided in advance, in particular by a manufacturer, such that they can be used (or reused or used further) for various applications.

In this way, in one embodiment, the operation of the application can be improved, in particular reliability can be increased and/or a startup and/or maintenance outlay can be reduced.

The present invention can be used particularly advantageously

for programming the application,

for executing the application, in particular to respond to error states or situations,

for monitoring the application, in particular for error states or situations, and/or

for evaluating the application, in particular to determine causes for error states or situations.

Accordingly, in one embodiment, operating an application of a robot system within the meaning of the present invention comprises (such) programming, executing, monitoring and/or evaluating the application.

In one embodiment, the first application situation module can comprise the linked modules (still as such) after the linking. Equally, in one embodiment (in the case of or in the first application situation module), said linked modules or links can also be eliminated, at least in part, such that the first application situation module maps the input signals onto the at least one output signal in accordance with rules, which (have) result(ed) from the link(s) or correspond thereto, without the linked modules themselves still be present or identifiable, or mapping input signals onto output signals.

In one embodiment, the robot system comprises, in one embodiment is, one or more robots, in particular one or more stationary and/or one or more mobile robots, wherein the or one of the plurality of robots comprises, in one embodiment, (in each case) at least three, in particular at least six, in one embodiment at least seven, axes or joints, in particular swivel joints, in one embodiment a robot arm comprising at least three, in particular at least six, in one embodiment at least seven, axes or joints, in particular swivel joints.

In addition or alternatively, in one embodiment, the robot system comprises one or more, preferably robot-guided, robot tools, in particular grippers, coating devices, in particular painting or adhesive heads or the like, welding devices, in particular welding guns, and/or machining devices, in particular drills, milling cutters, saws, laser heads or the like.

In addition or alternatively, in one embodiment, the robot system comprises one or more fixing devices and/or one or more transport devices, in particular conveying devices, transport vehicles or the like, and/or one or more storage devices, in particular memories or magazines or the like.

On account of its complexity, variability, mode of operation and/or security requirements, the present invention can be used particularly advantageously for robot systems of this kind.

In one embodiment, the linking is logic-based or rule-based linking and/or takes place, in one embodiment, on the basis of, in particular by specification of, one or more rules or axioms.

In one embodiment, a situation module within the meaning of the present invention (each) comprises a, preferably stored and/or data(-implemented) (knowledge) representation or description, in particular a (knowledge) representation or description of one or more components of the robot system, in particular one or more of the above-mentioned components of robot, robot tool, fixing device, transport device or storage device, and/or of the application or applications of an application class, in particular times, numbers of pieces, error states, or the like. In one embodiment, a situation module comprises one or more axioms or rules or (mapping) specifications, or corresponding structures, in particular data structures.

In one embodiment, one or more of the situation modules (each) maps one or more position input signals, which, in one embodiment, (each) quantifies a one-dimensional or multi-dimensional Cartesian position, a one-dimensional or multi-dimensional Cartesian orientation, and/or a one-dimensional or multi-dimensional joint position, one or more movement input signals, which, in one embodiment, (each) quantifies a one-dimensional or multi-dimensional speed and/or acceleration, and/or one or more load input signals, which, in one embodiment, (each) quantifies one or more contact and/or joint forces and/or torques, in one embodiment position, movement and/or load input signal(s) of one or more components of the robot system, in particular one or more of the above-mentioned components of robot, robot tool, fixing device, transport device or storage device, and/or of the application or applications of an application class, in particular times, numbers of pieces, error states or the like, onto one or more output signals, which, in turn, in one embodiment can be input signals of situation modules of higher complexity levels.

Situation modules of this kind can be used particularly advantageously for programming the application, for executing the application, in particular to respond to error states or situations, for monitoring the application, in particular for error states or situations, and/or for evaluating the application, in particular to determine causes for error states or situations.

In one embodiment, the situation module library comprises one or more predefined application-independent robot system situation modules of a first, low(er), in particular lowest, complexity level, and one or more predefined application-independent robot system situation modules of a second, higher complexity level, in one embodiment in addition (in each case) one or more predefined application-independent robot system situation modules of one or more further (in each case yet) higher complexity levels.

In addition or alternatively, in one embodiment, the first robot system situation module is linked to at least one application-class-specific application class situation module of one complexity level, and at least one application-class-specific application class situation module of a different complexity level that is higher than this one complexity level.

In addition or alternatively, in one embodiment, the first robot system situation module is linked to at least one application-specific application situation module of one complexity level, and at least one application-specific application situation module of a different complexity level that is higher than this one complexity level.

In one embodiment, one situation module has a higher complexity level, and two or more situation modules have a lower complexity level.

As a result, in one embodiment it is advantageously possible to create or use in particular successive (increasingly) (more) complex situation modules from simple(r) situation modules, in a development from simplest or atomic basic situation data. As a result, in one embodiment, the flexibility, reliability and/or user-friendliness can be improved.

In one embodiment, the mapping of the input signal or signals onto the output signal or signals of one or more of the situation modules is machine-learned, in one embodiment by means of artificial intelligence. As a result, in one embodiment particularly advantageous, in particular flexible, robust and/or precise, situation modules can be used.

According to one embodiment of the present invention, a system, in particular in terms of hardware and/or software, in particular in terms of programming, is configured to carry out a method described herein and/or comprises:

means for selecting a first robot system situation module from a situation module library,

which comprises a plurality of predefined application-independent robot system situation modules for the robot system, which in each case maps one or more input signals onto one or more output signals;

means for linking this first robot system situation module to

one or more additional selected robot system situation modules from the situation module library; and/or

one or more application-class-specific application class situation modules, which are (in each case) predefined for a class of a plurality of, in particular identical, applications, and (in each case) maps one or more input signals onto one or more output signals; and/or

one or more application-specific application situation modules, which (in each case) maps one or more input signals onto one or more output signals,

to form a first application situation module that maps input signals of its linked situation modules, i.e. of the first robot system situation module and of the further selected robot system situation module(s) and/or of the application class situation module(s) and/or of the application situation module(s) linked thereto, onto one or more output signals; and

means for operating the application on the basis of the first application situation module.

A means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or a plurality of programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate the application of the robot system. In one embodiment, a computer program product may comprise—and may in particular, be—a particularly non-volatile storage medium for storing a program, or having a program stored thereon, wherein an execution of this program causes a system or a controller, in particular a computer, to carry out the method described herein, or one or multiple steps thereof.

In one embodiment, one or more, in particular all, steps of the method are carried out completely or partially automatically, in particular by the system or its means.

In one embodiment, the system or the means thereof comprises the robot system and/or a situation module library described herein or a situation module library for a method described herein.

In one embodiment, a description of a current robot (system) situation is calculated and/or made available, which is application-dependent, in particular by means of the robot system situation module(s). In one embodiment, this description or robot system situation module is preferably machine-interpretable, and/or can be reused in different application contexts. In particular for such reusability, in one embodiment, a modular extension by application-specific knowledge is provided, in particular in order to augment application-independent aspects by application-specific ones.

An advantage that is achieved thereby in one embodiment is that component manufacturer can preferably deliver (at the same time) all component-specific but application-independent situation descriptions. The integrator or application developer can add the application-specific part on this basis. Thus, all parties involved are working in their field of expertise, and thus capable of displaying specific knowledge.

In the example of the robot application of setting terminals, illustrated at the outset, for example the robot manufacturer can implement the detection of individual traces or time series of different sources, in particular axis angles and/or torques, Cartesian positions or the like, along with the evaluation, in particular by means of machine-learning-based classification or data analysis methods. Said manufacturer can derive robot (system)-specific basic situation data therefrom, for example “axis 1 moves,” “constant force in Z-direction,” “momentum in X-direction” or the like, and model (more) complex situations by means of, in particular logical, combinations, for example “robot is moving,” “robot is in contact,” “collision has occurred,” or the like.

Thus, in one embodiment, the application developer is capable of describing application-specific situations on the basis of the application-independent ones, for example “robot is in contact with the DIN rail.”

In one embodiment, the first application situation module can be used to determine causes for observed error symptoms, in particular in that the possible symptoms are taken into account in the logical descriptions of the complex situations and causes of error. One possible use is that of isolating causes of error to an observed symptom.

In another embodiment, the first application situation module can be used to respond dynamically to eventualities arising in the application, and to make situation-based decisions regarding the further course of the program. For example, after “robot is in contact with the DIN rail,” the rotational movement for snapping-in takes place. If no snapping-in has occurred, this can be responded to by “put the component aside and pick a new one.” If an unexpected collision has occurred, this can be responded to by “activate a vision system,” in order to allow for further assessment of the situation. One embodiment of the present invention is used in intelligent process control for flexible and versatile production facilities.

One embodiment makes use of a formal knowledge representation approach for the situation modules, in one development an ontology, in another development formalism that offers the possibility of automatically mapping logical combinations of elements of the knowledge base and drawing automatic conclusions, in particular a logic program or a rule base.

If, in one embodiment, an ontology-based approach is used, then in a development an ontology is to be considered a set of axioms which describe logical correlations between entities. An entity can in particular constitute a concept, in this case in particular a situation (module). Therefore, in this case the axioms describe correlations between situations. As a result, it is possible to combine situations from very atomic, primitive and general situations to more complex and more specific situations.

In one embodiment, an axiom or a robot system situation module describes, in particular logically, the correlation whereby the robot moves when at least one of the axes thereof moves. Vice versa, an axiom or robot situation module describes that the robot does not move, if none of the axes thereof moves.

In one embodiment, an axiom or a robot system situation module of a second, higher complexity level describes that the robot is in contact if a constant force can be measured in at least one Cartesian direction. Vice versa, a robot is in free travel if it is not in contact, etc.

These correlations can all describe robots in the context of the system components, i.e. are application-independent.

In one embodiment, the ontologies or situation modules are designed in a modular manner, such that two ontologies or situation modules, considered together, result in a new ontology or a new situation module that consists of the union of the to axiom amounts. In particular, one ontology O_2 can import another ontology O_1, and is thus capable of reusing the entities which were described by axioms from O_1, and adding further axioms.

If for example the ontology O_1 is described by an axiom “robot is in contact,” the ontology O_2 can import this O_1 and then reuse the situation or entity “robot is in contact” and combine this to form further situations, by means of its own axioms. For example, “robot is moving towards the DIN rail” and “robot is in contact” can mean “robot is in contact with the DIN rail.”

In this way, in particular causes of error can be described, such as “robot in snap-in procedure of the electrical components” and “no force impulse” can mean “snap-in mechanism faulty.”

The correlations described in this example can be described in the context of the application, i.e. they are application-specific.

In one embodiment, a plurality of ontologies or situation modules of different abstraction planes can be used in this way. These form a chain of ontology or situation module imports and, in one embodiment, constitute the different layers of the robot as a movement machine, from pre-configured standard cells to specific client applications. One or more of the ontologies or situation modules are created by the responsible player of the relevant layer, and describe the situations relevant for this.

For example, the robot manufacturer describes the first ontology by way of basic situation data and basic situations such as “robot is moving,” but also “robot is in contact,” insofar as this can be determined by means of built-in sensors or in another manner, for example by means of motor currents or the like. A cell supplier can expand this ontology by situations as are characteristic for the class of the applications that can be implemented by the cell. For example, a pick-and-place cell can describe situations such as “object grasped” or the like. A specific application on the basis of the pick-and-place cell can specifically respond to the objects or the specific surroundings, and describe situations such as “electrical component grasped,” “set-down position occupied,” etc.

In one embodiment, for the purpose of cause of error determination in one or more planes or in one or more situation modules, (in each case) the corresponding observed symptoms, associated with the causes, are also modeled in the ontology or the situation module. In one embodiment, these symptoms do not differ, in technical terms, from basic situation data, but have the additional property that symptoms are described in the context of a problem situation. In one embodiment, basic situation data and/or symptoms can be identified automatically from the data, and/or set directly by means of user inputs or observations.

If, for example, the user observes incorrect behavior, for example that the robot is drifting in the gravitation compensation mode, they can report the symptom via a user interface. This can ultimately be combined, by means of the ontology or the situation module, with other basic situation data automatically determined from the data, to form more complex situations, and ultimately causes of error, for example an incorrect load data configuration or the like.

In one embodiment, an automatic inference algorithm (“reasoner”) is used for the logical evaluation of the ontology axioms or situation modules. The ontology language OWL (“Web Ontology Language”), used in one embodiment, advantageously makes it possible to describe axioms and entities, and is based on description logic. Established reasoning algorithms and implementations are available as a result.

In particular, in order to enable the application developer to model an application-specific ontology or an application-specific application situation module on the basis of the application-independent ontology or the predefined application-independent robot system situation modules of the component supplier, in one embodiment corresponding tool support is provided. In one embodiment, tool support of this kind detects, preferably in a user-friendly manner, in particular in a form-based manner, the correlations of the situations, and translates these, accordingly, into the ontology language or situation modules.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a robot system according to one embodiment of the present invention;

FIG. 2 illustrates a method for operating an application of the robot system according to one embodiment of the present invention; and

FIG. 3 illustrates a linked first application situation module according to one embodiment of the present invention.

### DETAILED DESCRIPTION

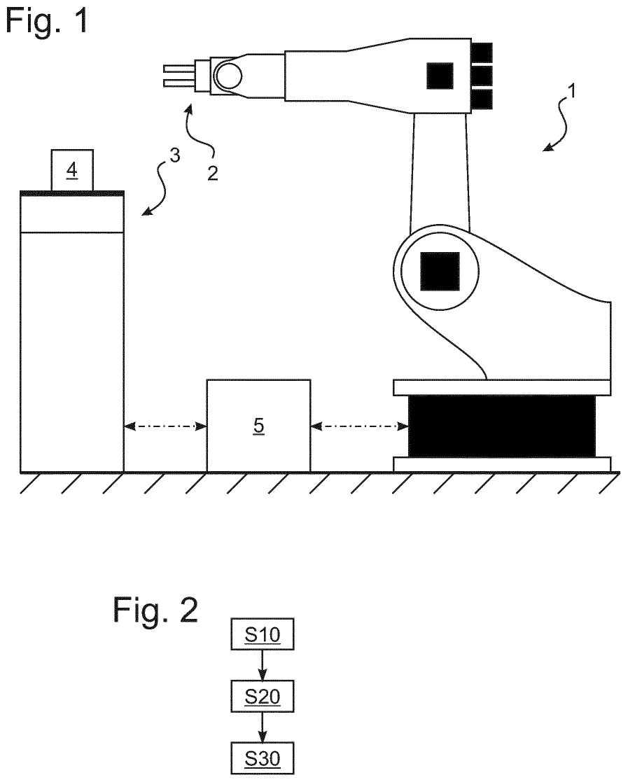

FIG. 1 shows a robot system for operating an application according to one embodiment of the present invention.

The robot system comprises a robot (arm) 1, which guides a robot tool 2, a conveying device 3 for conveying workpieces 4, and a cell controller 5 for controlling the robot system.

FIG. 2 illustrates a method for operating the application of the robot system according to one embodiment of the present invention.

In a first step S10, a user selects a first robot system situation module from a situation module library that comprises a plurality of predefined application-independent robot system situation modules for the robot system, each of which modules maps at least one input signal onto at least one output signal.

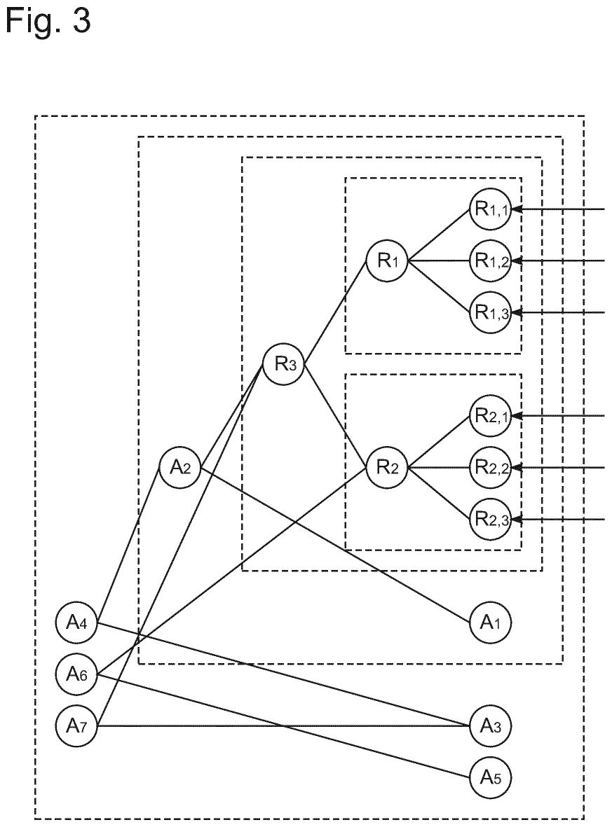

By way of example, in this respect a plurality of robot system situation modules R_{1, i}, i=1, . . . , 3 of a first, lowest complexity level, i.e. a plurality of robot system basic situation data R_{1, i}, are indicated in FIG. 3. Such robot system basic situation data for example map sensor data or traces of the robot 1 onto the situation or the output signal “axis 1 of the robot 1 is moving,” “axis 2 of the robot 1 is moving,” etc., “axis 6 of the robot 1 is moving.”

Furthermore, by way of example a plurality of robot system situation modules R_{2, i}, i=1, . . . , 3 of the first, lowest complexity level, i.e. a plurality of robot system basic situation data R_{2, i} are indicated in FIG. 3. Said robot system basic situation data for example map sensor data or traces of the robot 1 onto the situation or the output signal “no contact force on the robot 1 in X-direction,” “no force contact on the robot 1 in Y-direction,” etc.

In turn by way of example, and as also indicated in FIG. 3, these robot system basic situation data are also linked with more complex robot system situation modules R₁, R₂, R₃. These map the output signals of the robot system basic situation data onto output signals, for example according to the provision or the axiom: “at least one of the axes of the robot 1 is moving⇔robot 1 is moving” or “none of the axes of the robot 1 is moving⇔robot 1 is not moving” (R₁) or “contact force in at least one direction on the robot 1⇔robot 1 in contact” or “no contact force in any direction on the robot 1⇔robot 1 not in contact” (R₂) or “robot 1 is moving AND robot 1 not in contact⇔(collision-)free travel” or “robot 1 is not moving OR robot 1 in contact⇔no (collision-)free travel” (R₃).

In a step S20, the user links these predefined application-independent robot system situation modules from the situation module library with application-class-specific application class situation modules and/or application-specific application situation modules, which are indicated in FIG. 3 by Aᵢ, i=1, . . . , 7 and which can in turn be of different complexity levels. For example, an application-class-specific application class situation module “component grasped by robot” can be an application-specific, in particular first, application situation module “electrical component grasped by robot” or the like, or can map the corresponding input signals onto corresponding output signals.

On the basis of the situation modules thus linked to the first application situation module, in a step S30, the application can then be operated, in particular programmed, executed, monitored and/or evaluated, for example causes can be determined from observable error symptoms, or arising eventualities in the application can be reacted to dynamically.

Although embodiments have been explained in the preceding description, it is noted that a large number of modifications are possible.

It is also noted that the embodiments are merely examples that are not intended to restrict the scope of protection, the applications, and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot (arm)
2 Robot tool
3 Transport device
4 Workpiece
5 Cell controller
R_{i(, j)} Robot system situation module (i=1, 2, . . . ; j=1, 2, . . . )
Aᵢ Application (class) situation module (i=1, . . . , 7)

What is claimed is:

1-9. (canceled)

10. A method for operating an application of a robot system, the method comprising:
selecting a first robot system situation module from a situation module library that comprises a plurality of predefined application-independent robot system situation modules for the robot system, each of which modules maps at least one input signal onto at least one output signal;
linking the first robot system situation module to at least one of:
at least one additional selected robot system situation module from the situation module library,
at least one application-class-specific application class situation module that is predefined for a class of a plurality of applications and which maps at least one input signal onto at least one output signal, or
at least one application-specific application situation module that maps at least one input signal onto at least one output signal, to form a first application situation module that maps the input signals of its linked situation modules onto at least one output signal; and
operating the application on the basis of the first application situation module.

11. The method of claim 10, wherein the situation module library comprises at least one predefined application-independent robot system situation module of a first level of complexity, and at least one predefined application-independent robot system situation module of a second, higher level of complexity.

12. The method of claim 10, wherein mapping of the at least one input signal onto the at least one output signal of at least one of the situation modules is machine-learned.

13. The method of claim 10, wherein the robot system comprises at least one of:
at least one robot;
at least one robot tool;
at least one fixing device;
at least one transport device; or
at least one storage device.

14. The method of claim 10, further comprising:
mapping, with at least one of the situation modules, at least one of:
at least one position input signal,
at least one movement input signal, or
at least one load input signal
onto at least one output signal.

15. The method of claim 14, wherein the at least one position input signal, the at least one movement input signal, or the at least one load input signal are input signals of at least one component of the robot system.

16. The method of claim 10, wherein operating the application comprises at least one of programming, executing, monitoring, or evaluating the application.

17. A situation module library for a method of operating an application of a robot system, wherein a selected first robot system situation module is linked with at least one of:
at least one additional selected robot system situation module from the situation module library,
at least one application-class-specific application class situation module that is predefined for a class of a plurality of applications and which maps at least one input signal onto at least one output signal, or
at least one application-specific application situation module that maps at least one input signal onto at least one output signal, to form a first application situation module that maps the input signals of its linked situation modules onto at least one output signal;
the situation module library comprising:
a plurality of predefined application-independent robot system situation modules for the robot system, each of which modules maps at least one input signal onto at least one output signal.

18. A system for operating an application of a robot system, the system comprising:
means for selecting a first robot system situation module from a situation module library that comprises a plurality of predefined application-independent robot system situation modules for the robot system, each of which modules maps at least one input signal onto at least one output signal;
means for linking said first robot system situation module to at least one of:
at least one additional selected robot system situation module from the situation module library,
at least one application-class-specific application class situation module that is predefined for a class of a plurality of applications and maps at least one input signal onto at least one output signal, or
at least one application-specific application situation module that maps at least one input signal onto at least one output signal, to form a first application situation module that maps input signals of its linked situation modules onto at least one output signal; and
means for operating the application on the basis of the first application situation module.

19. A computer program product for operating an application of a robot system, the computer program product comprising program code stored on a non-transitory, computer-readable storage medium, the program code, when executed by a computer, causing the computer to:
select a first robot system situation module from a situation module library that comprises a plurality of predefined application-independent robot system situation modules for the robot system, each of which modules maps at least one input signal onto at least one output signal;
link the first robot system situation module to at least one of:
at least one additional selected robot system situation module from the situation module library,
at least one application-class-specific application class situation module that is predefined for a class of a plurality of applications and which maps at least one input signal onto at least one output signal, or
at least one application-specific application situation module that maps at least one input signal onto at least one output signal, to form a first application situation module that maps the input signals of its linked situation modules onto at least one output signal; and
operate the application on the basis of the first application situation module.
